(19) United States
(12) Patent Application Publication
(10) Pub. No.: US 2020/0045727 A1
(43) Pub. Date: Feb. 6, 2020

(54) SIB Scheduling for Private Networks

(71) Applicant: Parallel Wireless, Inc., Nashua, NH (US)

(72) Inventors: Praveen Kumar, Pune (IN); Pratik Vinod Mehta, Pune (IN)

(21) Appl. No.: 16/532,322

(22) Filed: Aug. 5, 2019

Related U.S. Application Data
(60) Provisional application No. 62/714,478, filed on Aug. 3, 2018.

(51) Int. Cl. H04W 72/12; H04W 72/04; H04W 48/12

(52) U.S. Cl. CPC H04W 72/1289; H04W 72/042; H04W 72/0446; H04W 48/12; H04W 72/1205

(57) ABSTRACT

Systems, methods and computer software are disclosed for scheduling System Information Blocks (SIBs). A Master Information Block (MIB) is transmitted at a first fixed cycle; starting from a first System Frame number (SFN). A first SIB is transmitted at a second fixed cycle and at a SIB offset after the SFN. Other SIBs are transmitted at cycles specified by a SIB scheduling information element in the first SIB.

### CROSS-REFERENCE TO RELATED APPLICATIONS

This application claims priority under 35 U.S.C. § 119(e) to U.S. Provisional Pat. App. No. 62/714,478, filed Aug. 3, 2018, titled “SIB Scheduling for Private Networks” which is hereby incorporated by reference in its entirety for all purposes. This application hereby incorporates by reference, for all purposes, each of the following U.S. Patent Application Publications in their entirety: US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; and US20170257133A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. Nos. 14/822,839, 15/828,427, U.S. Pat. App. Pub. Nos. US20170273134A1, US20170127409A1 in their entirety. Features and characteristics of and pertaining to the systems and methods described in the present disclosure, including details of the multi-RAT nodes and the gateway described herein, are provided in the documents incorporated by reference.

### BACKGROUND

User equipments (UEs) and mobile terminals are typically designed and configured to search for a mobile network according to a search sequence. Once a mobile network is identified and the UE is connected, the UE will display an indication of which mobile network the UE is connected to. This name is not physically sent from the network. Instead, identifying the carrier name that the phone displays on its screen is a tiered process. The base tier is that the phone compares a received PLMN (number) and displays the corresponding name (string) according to a carrier list stored within itself. This is different for Android, iOS etc.

Before the User Equipment (UE) can communicate with the network it must perform cell search and selection procedures and obtain initial system information. This involves acquiring slot and frame synchronization, finding out the cell identity and decoding the Master Information Block (MIB) and the System Information Blocks (SIBs). The MIB is carried on the Broadcast Channel (BCH) mapped into the Physical Broadcast Channel (PBCH). This is transmitted with a fixed coding and modulation scheme and can be decoded after the initial cell search procedure. With the information obtained from the MIB the UE can now decode the Control Format Indicator (CFI), which indicates the Physical Downlink Control Channel (PDCCH) length. This allows the PDCCH to be decoded, and searched for Downlink Control Information (DCI) messages. A DCI message CRC masked with System Information Radio Network Temporary Identifier (SI-RNTI) indicates that a SIB is carried in the same subframe. The SIBs are transmitted in the Broadcast Control Channel (BCCH) logical channel. Generally, BCCH messages are carried on the Downlink Shared Channel (DL-SCH) and transmitted on the Physical Downlink Shared Channel (PDSCH). The format and resource allocation of the PDSCH transmission is indicated by a DCI message on the PDCCH.

### SUMMARY

In one example embodiment, a method is disclosed for scheduling System Information Blocks (SIBs) that includes transmitting a Master Information Block (MIB) at a first fixed cycle; starting from a first System Frame number (SFN). The method also includes transmitting a first SIB at a second fixed cycle and at a SIB offset after the SFN. The method further includes transmitting other SIBs at cycles specified by a SIB scheduling information element in the first SIB.

In another example embodiment, a system for scheduling System Information Blocks includes a wireless network device, wherein the wireless network device transmits a Master Information Block (MIB) at a first fixed cycle; starting from a first System Frame number (SFN). The wireless network device transmits a first SIB at a second fixed cycle and at a SIB offset after the SFN. The wireless network device transmits other SIBs at cycles specified by a SIB scheduling information element in the first SIB.

In another example embodiment, a non-transitory computer-readable medium contains instructions for scheduling System Information Blocks (SIBS) which, when executed, cause a wireless network device to perform the following steps: transmitting a Master Information Block (MIB) at a first fixed cycle; starting from a first System Frame number (SFN); transmitting a first SIB at a second fixed cycle and at a SIB offset after the SFN; and transmitting other SIBs at cycles specified by a SIB scheduling information element in the first SIB.

### BRIEF DESCRIPTION OF THE DRAWINGS

FIG. 1 is a diagram showing MIB and SIB scheduling, in accordance with some embodiments.

FIG. 2 is a log showing SIB1 transmissions, in accordance with some embodiments.

FIG. 3 is a diagram showing a single SIB transmission, in accordance with some embodiments.

FIG. 4 is a diagram showing multiple SIB transmissions, in accordance with some embodiments.

FIG. 5 is a timing listing showing MIB and SIB transmissions, in accordance with some embodiments.

FIG. 6 is a flow diagram for MIB and SIB scheduling, in accordance with some embodiments.

FIG. 7 is a network diagram in accordance with some embodiments.

FIG. 8 is an enhanced eNodeB for performing the methods described herein, in accordance with some embodiments.

FIG. 9 is a coordinating server for providing services and performing methods as described herein, in accordance with some embodiments.

### DETAILED DESCRIPTION

In some cases a carrier may want to provide a private access network that is not accessible or searchable using a standard mobile terminal or user equipment (UE). Or, in some cases a carrier may want mobile devices to display an altered mobile network display indication, or no indication at all, which means using a non-standard PLMN. One option for doing so is to broadcast the LTE signals (SIB) at a different offset than the standard and thus normal UEs won't find us; but modified phones would.

It should be appreciated that while SIB is discussed with reference to 4G and 5G radio access technologies, the present application also applies to 2G and 3G equivalents of SIBs, e.g., Cell Broadcasting Service (CBS), or any other equivalent corresponding to any other radio access technology (RAT).

3GPP TS 36.214, the latest published version thereof as of the date of this application, is hereby incorporated by reference in its entirety for all purposes.

SIB Scheduling

In LTE, MIB, SIB1, SIB2 is mandated to be transmitted for any cells. Since many of the SIB are transmitted, it should be transmitted in such a way that the location (subframe) where a SIB is transmitted should not be the same subframe where another SIB is transmitted.

Overall a SIB Scheduling concept is as follows. A MIB is transmitted at fixed cycles (every 4 frames starting from System Frame number (SFN) 0). A first SIB (SIB1) is also transmitted at the fixed cycles (every 8 frames starting from SFN 0). All other SIB are being transmitted at the cycles specified by SIB scheduling information elements in SIB 1.

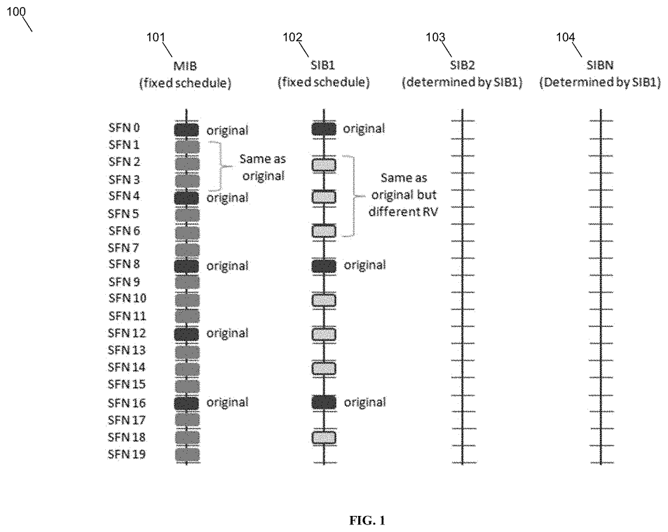

FIG. 1 shows an example MIB and SIB schedule 100. The MIB is shown 101 is fixed as is the SIB1 schedule 102. The schedules for SIB2 103 and SIBN 104 are determined by SIB 1.

You may notice that LTE SIB1 is very similar to WCDMA MIB. If you set this value incorrectly, all the other SIBs will not be decoded by UE. This means, even though all the SIB is being transmitted, the UE would be trying to decode them at the wrong timing. And as a result, UE would not recognize the cell and show “No Service” message.

According to 36.331 section 5.2.1.2, the MIB scheduling is as follows :

The MIB uses a fixed schedule with a periodicity of 40 milliseconds (9ms) and repetitions made within 40 ms. The first transmission of the MIB is scheduled in subframe #0 of radio frames for which the SFN mod 4=0, and repetitions are scheduled in subframe #0 of all other radio frames.

According to 36.331 section 6.2.2 Message definitions—MasterinformationBlock field descriptions, the System Frame Number in MIB is specified as follows:

Defines the 8 most significant bits of the SFN. As indicated in TS 36.211 [21, 6.6.1], the 2 least significant bits of the SFN are acquired implicitly in the P-BCH decoding, i.e. timing of 40ms P-BCH TTI indicates 2 least significant bits(within 40ms P-BCH TTI, the first radio frame: 00, the second radio frame: 01, the third radio frame: 10, the last radio frame: 11). One value applies for all serving cells (the associated functionality is common i.e. not performed independently for each cell).

According to 36.331 section 5.2.1.2, the SIB1 scheduling is as follows :

The SystemInformationBlockType1 uses a fixed schedule with a periodicity of 80 ms and repetitions made within 80 ms. The first transmission of SystemInformationBlockType1 is scheduled in subframe #5 of radio frames for which the SFNmod 8=0, and repetitions are scheduled in subframe #5 of all other radio frames for which SFN mod 2=0.

This means that even though SIB1 periodicity is 80 ms, different copies (redundant version or RV) of the SIB1 is transmitted every 20ms. Meaning that at L3 you will see the SIB1 every 80 ms, but at PHY layer you will see it every 20ms. For the detailed RV assignment for each transmission, refer to 36.321 section 5.3.1 (the last part of the section).

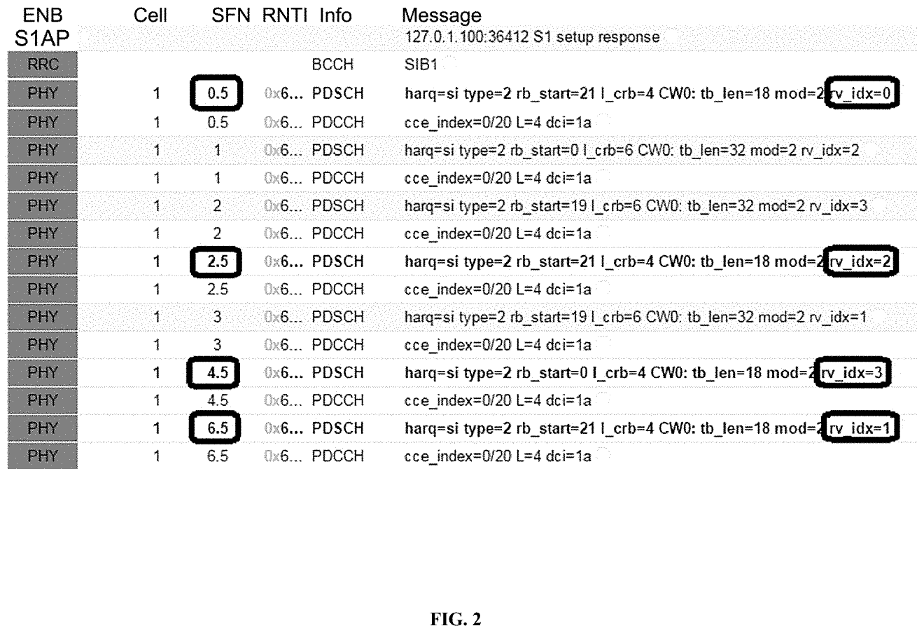

FIG. 2 shows a log 201 showing the SIB1 transmission as described above. Check SFN.subframe timing and RV index. The transmission cycles for other SIBs are determined by schedulingInfoList in SIB1 as shown in the following example (This example is the case where SIB2 and 3 are being transmitted).

+-schedulingInfoList ::= SEQUENCE OF
SIZE(1..maxSI-Message[32]) [2]
| +-SchedulingInfo ::= SEQUENCE
| | +-si-Periodicity ::= ENUMERATED [rf16]
| | +-sib-MappingInfo ::= SEQUENCE OF SIZE(0..maxSIB-1[31]) [0]
| +-SchedulingInfo ::= SEQUENCE
| +-si-Periodicity ::= ENUMERATED [rf32]
| +-sib-MappingInfo ::= SEQUENCE OF SIZE(0..maxSIB-1[31]) [1]
| +-SIB-Type ::= ENUMERATED [sibType3]
+-tdd-Config ::= SEQUENCE OPTIONAL:Omit
+-si-WindowLength ::= ENUMERATED [ms20]

It can be recognized that sib-MappingInfo IE in the first node is not specified, but the first entity of schedulingInfoList should always be for SIB2 as specified in the 36.331 as follows (See 36.331 SystemInformationBlockType1 field description).

List of the SIBs mapped to this SystemInformation message. There is no mapping information of SIB2; it is always present in the first SystemInformation message listed in the schedulingInfoList list.

Understanding overall cycle in the unit of Subframe number is pretty straightforward to understand. But understanding exactly at which subframe a SIB should be transmitted is not that straightforward as you might think. It is related to ‘si-WindowLength’. si-WindowLength tells that a SIB should be transmitted somewhere within the window length starting at the SFN specified by si-Periodicity. But this parameter does not specify the exact subframe number for the transmission.

The subframe for a specific SIB transmission is determined by an algorithm defined in 36.331 5.2.3 Acquisition of an SI message as follows.

When acquiring an SI message, the UE shall:

Determine the start of the SI-window for the concerned SI message as follows: for the concerned SI message, determine the number n which corresponds to the order of entry; in the list of SI messages configured by schedulingInfoList in SystemInformationBlockType1; determine the integer value x=(n−1)*w, where w is the si-WindowLength; the SI-window starts at the subframe #a, where a=x mod 10, in the radio frame for which SFN mod T=FLOOR(x/10), where T is the si-Periodicity of the concerned SI message; E-UTRAN should configure an SI-window of 1 ms only if all SIs are scheduled before subframe #5 in radio frames for which SFN mod 2=0.

Receive DL-SCH using the SI-RNTI from the start of the SI-window and continue until the end of the SI-window whose absolute length in time is given by si-WindowLength, or until the SI message was received, excluding the following subframes: subframe #5 in radio frames for which SFN mod 2=0; MBSFN subframes; any uplink subframes in TDD.

If the SI message was not received by the end of the SI-window, repeat reception at the next SI-window occasion for the concerned SI message;

### EXAMPLE 1

### SIB Transmitted

Following is SIB transmission shown on Resource Map Display tool of Amarisoft. SIB scheduling in this example is as follows.

```
    {
  message c1: systemInformationBlockType1: {
  ....
  schedulingInfoList {
    {
    si-Periodicity rf16,
    sib-MappingInfo {
      sibType3
    }
    }
  },
  si-WindowLength ms40,
  systemInfoValueTag 8
  }
}
```

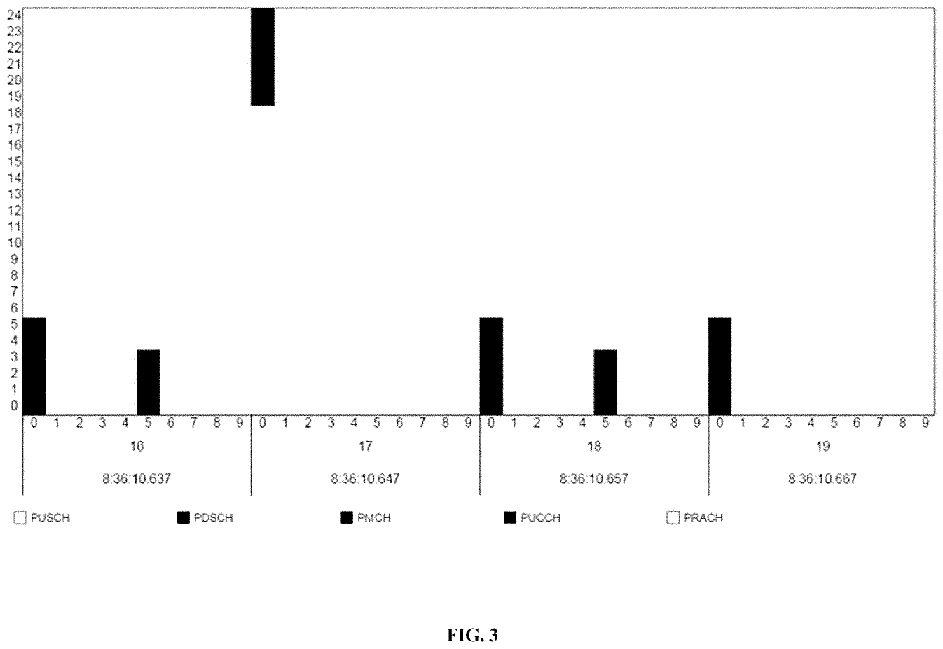

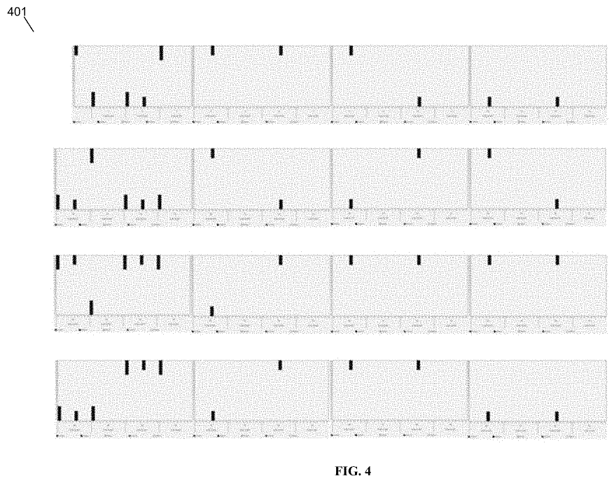

FIG. 3 is an image of a SIB 300. FIG. 4 is multiple images from the RB map and put in sequence to give you an image of overall SIB transmission pattern 400.

Referring back to FIG. 1, from the text log, you can confirm exact SFN. Subframe timing and Original/Retransmission (in case of SIB1).

Following is a SIBs captured from a live network.

```

[symbol]
_systemInformationBlockType1 [symbol]
    _cellAccessRelatedInfo [symbol]
    _cellSelectionInfo
    | _freqBandIndicator 4 [symbol]
    _schedulingInfoList
    | [symbol]   _SchedulingInfo
    | | _si-Periodicity rf8
    | [symbol]   _sib-MappingInfo
    | |_SIB-Type sibType3
    | |_SIB-Type sibType5
    | |_SIB-Type sibType6
    |_ si-WindowLength ms10
    |_ systemInfoValueTag 1
```

In some embodiments, it is enabled to provide private network SIBs that are not visible to ordinarily configured mobile devices, as follows.

Per the standard, MIB is transmitted at a fixed cycle (every 4 frames starting from SFNO) i.e SFN mod 4==0; SIB1 is transmitted at fixed cycles (every 8 frames starting from SFNO) i.e. SFN mod 8==0; and all the other SIBs are being transmitted at the cycles specified by SIB Scheduling information element in SIB 1.

Per a new method of SIB Scheduling, a SIB1_OFFSET is defined and applied to the SIB1 transmission. The enhanced base station shall transmit the SIB1 at SFN which suffices SFN mod (8+SIB_OFFSET)==0. This way SIB1 is shifted via SIB1_OFFSET. Due to which normal UE will not able to determine the Cell. If UE does not decode SIB1, UE will not be able to determine other SIB as well. We will update this SIB-OFFSET to the UE baseband software as well, so the UE also knows how to calculate the subframe number which carries SIB1 information. This enables dynamic SIB offset, channel sizing, or channel movement. In some embodiments this may be configurable by the network operator. In some embodiments this may be configurable remotely if the UE is first connected to the mobile operator according to a standard connection. In other embodiments this is preconfigured at the factory of the UE or preprogrammed into SIM cards.

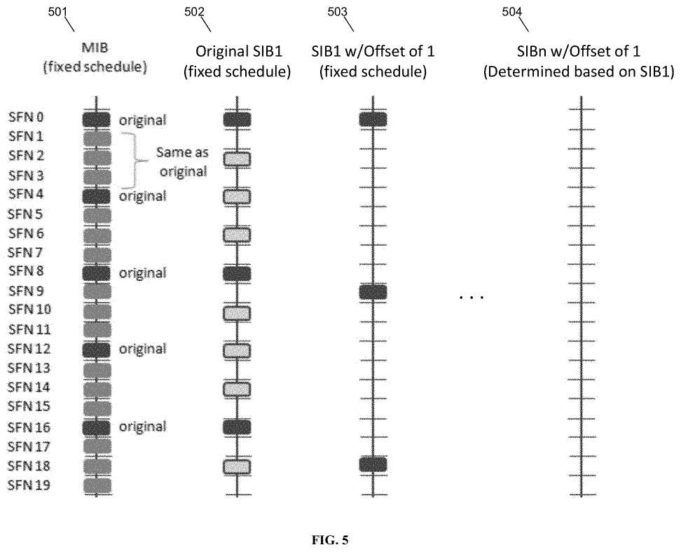

This is shown in FIG. 5. Schedule 501 shows a broadcast schedule for the MIB on a fixed schedule, according to the standard, with original MIBs being broadcast every 4 SFNs (SFN 0, SFN 4, SFN 8, etc.) and redundant values being broadcast during each additional SFN. Schedule 502 shows an original SIB1 broadcast according to the fixed schedule prescribed by the standard, with original SIB1s being broadcast at SFN 0, SFN 8, SFN 16, etc. and redundant values being broadcast at, e.g., SFN 2, SFN 4, SFN 6, SFN 10, SFN 12, SFN 14, SFN 18. The schedule is a fixed schedule. Schedule 503 shows an SIB broadcast schedule with an SIB1 OFFSET of 1. SIB1 is broadcast at SFN 0, SFN 9, SFN 18, . . . e.g., SFN mod (8+SIB1_OFFSET)==0, where SIB_OFFSET==1.The schedule is a fixed schedule. Schedule 504 shows that further SIBs are also broadcast but are determined based on SIB 1.

The above invention can be implemented in whole or in part at the eNodeB (or multi-RAT node) or at a coordinating server, or both, or using any split thereover.

In some embodiments, when acquiring an SI message, the UE shall now determine the start of the SI-window for the concerned SI message according to the standard method, only with an updated si-Periodicity, so that T is the si-Periodicity according to the standard, plus SIB1_OFFSET. The UE shall be configured by the mobile operator with the SIB1_OFFSET. These SIBs are invisible to UEs that are not configured.

In some embodiments, multiple private networks can be enabled using different SIB1_OFFSET parameters configured at the mobile operator. Different UEs may be configured with different SIB offset parameters, enabling the multiple private networks to be isolated from each other. In some embodiments, the multiple private networks may have custom configured mobile network name display indicators (user-displayed PLMN names).

In some embodiments, multi-operator core network (MOCN) may be supported, as follows. The cellular network broadcasts multiple isolated SIBs. Each UE is able to see one core network and attaches to it. The cellular network, at the core network (such as at an HNG), determines, based on signaling from the UE, which core network is being referred to by the UE, and directs traffic to and from it. The base station can be transparent to the MOCN signaling in this process, or the base station can support multiple core networks accordingly. The HNG is also able to provide transparent support for both hidden (e.g., SIB-masked) and non-hidden networks being broadcast at the same time, subject to the restriction that SIBs should not be broadcast over each other; the HNG can provide automatic checking functionality to avoid this.

A HetNet Gateway (HNG) may be included as part of the network and includes a different module for each Radio Access Technology (RAT). For example, there is a 2G module for processing 2G signaling, a 3G module for processing 3G signaling, a 4G module for processing 4G signaling and a 5G module for processing 5G signaling. Each module is able to process the SIBs or their equivalent for each supported RAT.

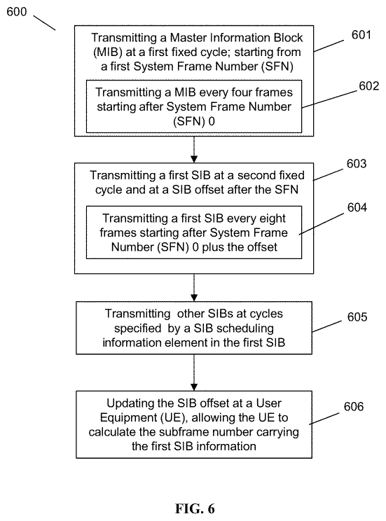

FIG. 6 is a flow diagram an example embodiment of a method 600 for scheduling System Information Blocks (SIBs). Method 600 begins with processing block 601 which discloses transmitting a Master Information Block (MIB) at a first fixed cycle; starting from a first System Frame number (SFN). As shown in processing block 602, transmitting a MIB at a first fixed cycle comprises transmitting a MIB every four frames starting after System Frame Number (SFN) 0.

Processing block 603 recites transmitting a first SIB at a second fixed cycle and at a SIB offset after the SFN. As shown in processing block 604, wherein transmitting a first SIB at a first fixed cycle comprises transmitting a first SIB every eight frames starting after System Frame Number (SFN) 0 plus the offset.

Processing block 605 discloses transmitting other SIBs at cycles specified by a SIB scheduling information element in the first SIB. Processing block 606 shows updating the SIB offset at a User Equipment (UE), allowing the UE to calculate the subframe number carrying the first SIB information.

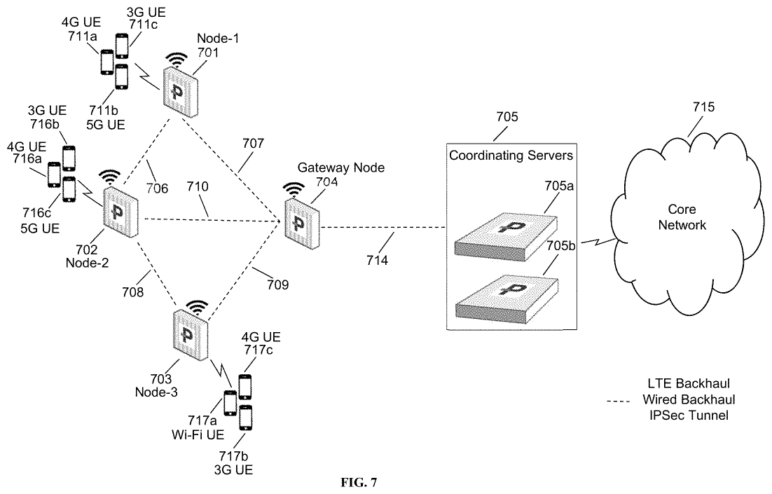

FIG. 7 is a network diagram in accordance with some embodiments. In some embodiments, as shown in FIG. 7, a mesh node 1 701, a mesh node 2 702, and a mesh node 3 703 are any G RAN nodes. Base stations 701, 702, and 703 form a mesh network establishing mesh network links 706, 707, 708, 709, and 710 with a base station 704. The mesh network links are flexible and are used by the mesh nodes to route traffic around congestion within the mesh network as needed. The base station 704 acts as gateway node or mesh gateway node, and provides backhaul connectivity to a core network to the base stations 701, 702, and 703 over backhaul link 714 to a coordinating server(s) 705 and towards core network 715. The Base stations 701, 702, 703, 704 may also provide eNodeB, NodeB, Wi-Fi Access Point, Femto Base Station etc. functionality, and may support radio access technologies such as 2G, 3G, 4G, 5G, Wi-Fi etc. The base stations 701, 702, 703 may also be known as mesh network nodes 701, 702, 703.

The coordinating servers 705 are shown as two coordinating servers 705a and 705b. The coordinating servers 705a and 705b may be in load-sharing mode or may be in active-standby mode for high availability. The coordinating servers 705 may be located between a radio access network (RAN) and the core network and may appear as core network to the base stations in a radio access network (RAN) and a single eNodeB to the core network, i.e., may provide virtualization of the base stations towards the core network. As shown in FIG. 7, various user equipments 711a, 711b, 711c are connected to the base station 701. The base station 701 provides backhaul connectivity to the user equipments 711a, 711b, and 711c connected to it over mesh network links 706, 707, 708, 709, 710 and 714. The user equipments may be mobile devices, mobile phones, personal digital assistant (PDA), tablet, laptop etc. The base station 702 provides backhaul connection to user equipments 712a, 712b, 712c and the base station 703 provides backhaul connection to user equipments 713a, 713b, and 713c. The user equipments 711a, 711b, 711c, 712a, 712b, 712c, 713a, 713b, 713c may support any radio access technology such as 2G, 3G, 4G, 5G, Wi-Fi, WiMAX, LTE, LTE-Advanced etc. supported by the mesh network base stations, and may interwork these technologies to IP.

In some embodiments, depending on the user activity occurring at the user equipments 711a, 711b, 711c, 712a, 712b, 712c, 713a, 713b, and 713c, the uplink 714 may get congested under certain circumstances. As described above, to continue the radio access network running and providing services to the user equipments, the solution requires prioritizing or classifying the traffic based at the base stations 701, 702, 703. The traffic from the base stations 701, 702, and 703 to the core network 715 through the coordinating server 705 flows through an IPSec tunnel terminated at the coordinating server 705. The mesh network nodes 701, 702, and 703 adds IP Option header field to the outermost IP Header (i.e., not to the pre-encapsulated packets). The traffic may from the base station 701 may follow any of the mesh network link path such as 707, 706-110, 706-108-109 to reach to the mesh gateway node 704, according to a mesh network routing protocol.

Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than SlAP, or the same protocol, could be used, in some embodiments.

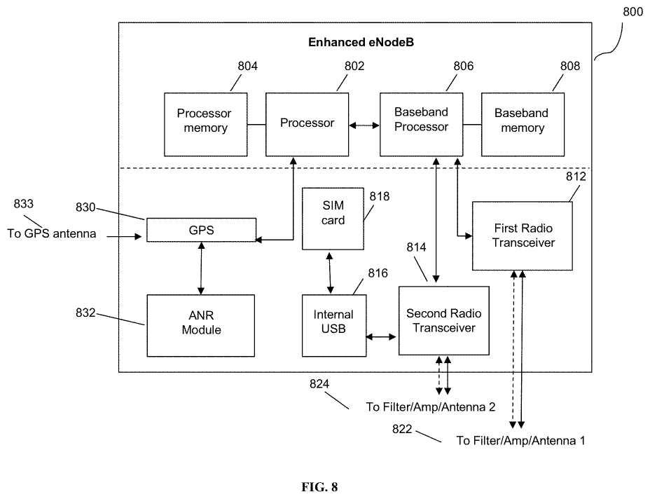

FIG. 8 is an enhanced eNodeB for performing the methods described herein, in accordance with some embodiments. Mesh network node 800 may include processor 802, processor memory 804 in communication with the processor, baseband processor 806, and baseband processor memory 808 in communication with the baseband processor. Mesh network node 800 may also include first radio transceiver 812 and second radio transceiver 814, internal universal serial bus (USB) port 816, and subscriber information module card (SIM card) 818 coupled to USB port 816. In some embodiments, the second radio transceiver 814 itself may be coupled to USB port 816, and communications from the baseband processor may be passed through USB port 816. The second radio transceiver may be used for wirelessly backhauling eNodeB 800.

Processor 802 and baseband processor 806 are in communication with one another. Processor 802 may perform routing functions, and may determine if/when a switch in network configuration is needed. Baseband processor 806 may generate and receive radio signals for both radio transceivers 812 and 814, based on instructions from processor 802. In some embodiments, processors 802 and 806 may be on the same physical logic board. In other embodiments, they may be on separate logic boards.

Processor 802 may identify the appropriate network configuration, and may perform routing of packets from one network interface to another accordingly. Processor 802 may use memory 804, in particular to store a routing table to be used for routing packets. Baseband processor 806 may perform operations to generate the radio frequency signals for transmission or retransmission by both transceivers 810 and 812. Baseband processor 806 may also perform operations to decode signals received by transceivers 812 and 814. Baseband processor 806 may use memory 808 to perform these tasks.

The first radio transceiver 812 may be a radio transceiver capable of providing LTE eNodeB functionality, and may be capable of higher power and multi-channel OFDMA. The second radio transceiver 814 may be a radio transceiver capable of providing LTE UE functionality. Both transceivers 812 and 814 may be capable of receiving and transmitting on one or more LTE bands. In some embodiments, either or both of transceivers 812 and 814 may be capable of providing both LTE eNodeB and LTE UE functionality. Transceiver 812 may be coupled to processor 802 via a Peripheral Component Interconnect-Express (PCI-E) bus, and/or via a daughtercard. As transceiver 814 is for providing LTE UE functionality, in effect emulating a user equipment, it may be connected via the same or different PCI-E bus, or by a USB bus, and may also be coupled to SIM card 818. First transceiver 812 may be coupled to first radio frequency (RF) chain (filter, amplifier, antenna) 822, and second transceiver 814 may be coupled to second RF chain (filter, amplifier, antenna) 824.

SIM card 818 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 800 is not an ordinary UE but instead is a special UE for providing backhaul to device 800.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 812 and 814, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 802 for reconfiguration.

A GPS module 830 may also be included, and may be in communication with a GPS antenna 832 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 832 may also be present and may run on processor 802 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

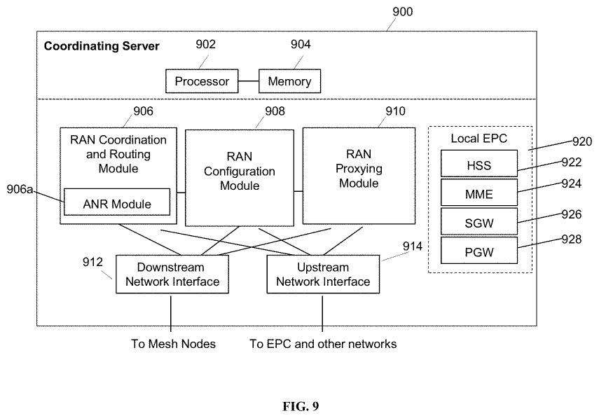

FIG. 9 is a coordinating server for providing services and performing methods as described herein, in accordance with some embodiments. Coordinating server 900 includes processor 902 and memory 904, which are configured to provide the functions described herein. Also present are radio access network coordination/routing (RAN Coordination and routing) module 906, including ANR module 906a, RAN configuration module 908, and RAN proxying module 910. The ANR module 906a may perform the ANR tracking, PCI disambiguation, ECGI requesting, and GPS coalescing and tracking as described herein, in coordination with RAN coordination module 906 (e.g., for requesting ECGIs, etc.). In some embodiments, coordinating server 900 may coordinate multiple RANs using coordination module 906. In some embodiments, coordination server may also provide proxying, routing virtualization and RAN virtualization, via modules 910 and 908. In some embodiments, a downstream network interface 912 is provided for interfacing with the RANs, which may be a radio interface (e.g., LTE), and an upstream network interface 914 is provided for interfacing with the core network, which may be either a radio interface (e.g., LTE) or a wired interface (e.g., Ethernet).

Coordinator 900 includes local evolved packet core (EPC) module 920, for authenticating users, storing and caching priority profile information, and performing other EPC-dependent functions when no backhaul link is available. Local EPC 920 may include local HSS 922, local MME 924, local SGW 926, and local PGW 928, as well as other modules. Local EPC 920 may incorporate these modules as software modules, processes, or containers. Local EPC 920 may alternatively incorporate these modules as a small number of monolithic software processes. Modules 906, 908, 910 and local EPC 920 may each run on processor 902 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than SlAP, or the same protocol, could be used, in some embodiments.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, legacy TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A method for scheduling System Information Blocks (SIBs), comprising:
transmitting a Master Information Block (MIB) at a first fixed cycle; starting from a first System Frame number (SFN);
transmitting a first SIB at a second fixed cycle and at a SIB offset after the SFN; and
transmitting other SIBs at cycles specified by a SIB scheduling information element in the first SIB.

2. The method of claim 1, wherein transmitting a MIB at a first fixed cycle comprises transmitting a MIB every four frames starting after System Frame Number (SFN) 0.

3. The method of claim 1, wherein transmitting a first SIB at a first fixed cycle comprises transmitting a first SIB every eight frames starting after System Frame Number (SFN) 0 plus the offset.

4. The method of claim 1 further comprising updating the SIB offset at a User Equipment (UE), allowing the UE to calculate the subframe number carrying the first SIB information.

5. The method of claim 1 wherein the transmitting a MIB, transmitting a first SIB and transmitting other SIBs are performed by an eNodeB.

6. The method of claim 1 wherein the transmitting a MIB, transmitting a first SIB and transmitting other SIBs are performed by a Multi Radio Access Network (RAN) node.

7. The method of claim 1 wherein the transmitting a MIB, transmitting a first SIB and transmitting other SIBs are performed by a coordinating server.

8. The method of claim 1 wherein the transmitting a MIB, transmitting a first SIB and transmitting other SIBs are performed in part by at least two of an eNodeB, a Multi Radio Access Network (RAN) node, and a coordinating server.

9. A system for scheduling System Information Blocks (SIBs), comprising:
a wireless network device;
wherein the wireless network device transmits a Master Information Block (MIB) at a first fixed cycle; starting from a first System Frame number (SFN);
transmits a first SIB at a second fixed cycle and at a SIB offset after the SFN; and
transmits other SIBs at cycles specified by a SIB scheduling information element in the first SIB.

10. The system of claim 9, wherein the wireless network device transmits a MIB every four frames starting after System Frame Number (SFN) 0.

11. The system of claim 9, wherein the wireless network device transmits a first SIB every eight frames starting after System Frame Number (SFN) 0 plus the offset.

12. The system of claim 9 wherein the wireless network device updates the SIB offset at a User Equipment (UE), allowing the UE to calculate the subframe number carrying the first SIB information.

13. The system of claim 9 wherein wireless network devices comprises an eNodeB.

14. The system of claim 9 wherein wireless network devices comprises a Multi Radio Access Network (RAN) node.

15. The system of claim 9 wherein wireless network devices comprises a coordinating server.

16. The system of claim 9 wherein the transmitting a MIB, transmitting a first SIB and transmitting other Ms are performed in part by at least two of an eNodeB, a Multi Radio Access Network (RAN) node, and a coordinating server.

17. A non-transitory computer-readable medium containing instructions for scheduling System Information Blocks (SIBs) which, when executed, cause a wireless network device to perform steps comprising:
transmitting a Master Information Block (MIB) at a first fixed cycle; starting from a first System Frame number (SFN);
transmitting a first SIB at a second fixed cycle and at a SIB offset after the SFN; and
transmitting other SIBs at cycles specified by a SIB scheduling information element in the first SIB.

18. The non-transitory computer-readable medium of claim 17, wherein instructins for transmitting a MIB at a first fixed cycle comprises instructions for transmitting a MIB every four frames starting after System Frame Number (SFN) 0.

19. The non-transitory computer-readable medium of claim 17, wherein instructions for transmitting a first SIB at a first fixed cycle comprises instructions for transmitting a first SIB every eight frames starting after System Frame Number (SFN) 0 plus the offset.

20. The non-transitory computer-readable medium of claim 17 further comprising instructions for updating the SIB offset at a User Equipment (UE), allowing the UE to calculate the subframe number carrying the first SIB information.
